(19) United States
(12) Patent Application Publication
(10) Pub. No.: US 2023/0173773 A1
(43) Pub. Date: Jun. 8, 2023

(54) METHOD FOR PRODUCING A SPECTACLE ARM

(71) Applicant: Silhouette International Schmied AG, Linz (AT)

(72) Inventor: Martin Lauber, Marchtrenk (AT)

(21) Appl. No.: 17/911,556

(22) PCT Filed: Feb. 16, 2021
(86) PCT No.: PCT/AT2021/060053

§ 371 Date: Sep. 14, 2022

(30) Foreign Application Priority Data
May 4, 2020 (AT) A50376/2020

(51) Int. Cl. B29D 12/02; G02C 5/00; G02C 5/18

(52) U.S. Cl. CPC B29D 12/02; G02C 5/008; G02C 5/18; B33Y 80/00; G02C 2200/10

(57) ABSTRACT

A method produces a spectacle arm that has an arm body (1) made of plastics material and a metal support inlay (3), in which method the arm body (1) is manufactured additively with a receiving recess for the support inlay (3) and then the support inlay (3) is introduced into the receiving recess of the arm body (1). The arm body (1) is manufactured additively with a longitudinal groove (2) as the receiving recess, which extends at least along a portion of the arm body, and the longitudinal groove (2) with the introduced support inlay (3) is injected with plastics material.

### FIELD OF THE INVENTION

The invention relates to a method for producing a spectacle arm which has an arm body made of plastic and a metallic support inlay, wherein the arm body is manufactured additively with a receiving recess for the support inlay and then the support inlay is introduced into the receiving recess of the arm body, and to a spectacle arm having an additively manufactured arm body.

### DESCRIPTION OF THE PRIOR ART

Additive manufacturing of spectacle arms, for example by selective laser sintering, but also with other printing processes, is particularly suitable for arm production in small batches. However, additive manufacturing processes are not suitable for providing metallic support inlays in the arm body. In order to avoid having to dispense with metallic support inlays in additively manufactured plastic arm bodies, it is known (EP 3 413 120 A1) to manufacture the arm body with a receiving recess in the form of a longitudinal channel into which the wire-shaped support inlay is then axially shot. A disadvantage, however, is that the sinter powder must be removed laboriously from the longitudinal channel of the additively manufactured arm body before the wire-shaped support inlay can be shot into the longitudinal channel from one of the end faces of the arm body. In addition, the possible design of the support inlay is considerably limited with regard to axial insertion into the longitudinal channel.

Because of the largely straight axial course of the longitudinal channel required for the insertion, the arm body cannot be subjected to major deformations in the course of the arm until after the support inlay has been inserted. In addition, changes in the cross-section of the support inlay are only possible to a limited extent.

### SUMMARY OF THE INVENTION

The invention is thus based on the object of designing a method for producing a spectacle arm which has an additively manufactured plastic spectacle body with a metallic support inlay in such a way that no restrictions have to be accepted with regard to the design of the arm and the support inlay.

Based on a method of the type described at the beginning, the invention solves the problem by additively manufacturing the arm body with a longitudinal groove as the receiving recess which extends at least along a portion of the arm body, and the longitudinal groove with the inserted support inlay is injected with plastic.

The provision of a longitudinal groove as a receiving recess for the support inlay creates the prerequisite for simple insertion of the support inlay into the receiving recess of the additively manufactured arm body, because this support inlay can be inserted transversely to its longitudinal axis into the longitudinal groove open over its length. The arm body can thus already be printed essentially in accordance with the desired arm shape with a course of the longitudinal groove following this arm shape, into which the support inlay preformed in accordance with this course is then inserted. The support inlay can be provided with different cross-sections over its length, e.g. for adaptation to different strength and deformation requirements, because these changes in cross-section can be taken into account either by the space available in the longitudinal groove or by a corresponding shaping of the longitudinal groove. The form-fit retention of the support inlay in the longitudinal groove is, after all, ensured by injecting plastic into the longitudinal groove accommodating the support inlay.

Additively manufactured arm bodies generally have a surface which does not meet the requirements to be placed on an arm surface and therefore requires finishing or coating. Depending on the materials and working methods used, this surface finishing of the arm body can be carried out either before the support inlay is inserted in the longitudinal groove or only after plastic was injected into the longitudinal groove provided with the support inlay.

The spectacle arms manufactured according to the invention are characterized by extensive freedom of design, both with regard to the arm shape and the design of the support inlay, wherein not only comparatively simple manufacturing conditions are maintained, but also the respective mechanical load requirements can be advantageously addressed. The injection of plastic into the longitudinal groove of the arm body, which accommodates the support inlay, advantageously ensures tolerance compensation due to the form-fit connection between the support inlay and the arm body via the injection molding closure of the longitudinal groove, so that the support function of the support inlay for the spectacle arm is fully effective. Depending on the choice of material and the surface finish of the arm, the injection molding closure of the longitudinal groove can either be visually suppressed or used as a design element.

For better fixing of the support inlay in the longitudinal groove of the arm body, the ends of the support inlay can engage in blind holes on the end faces of the longitudinal groove. For the same purpose, the longitudinal groove can have clamping catches distributed along its length for the inserted support inlay.

If the longitudinal groove forms an undercut, this undercut is underlaid by the injection with plastic with the effect that the thus resulting form-fit improves the connection between the arm body and the injection with plastic.

### BRIEF DESCRIPTION OF THE INVENTION

The method according to the invention is explained in more detail on the basis of the drawing, wherein:

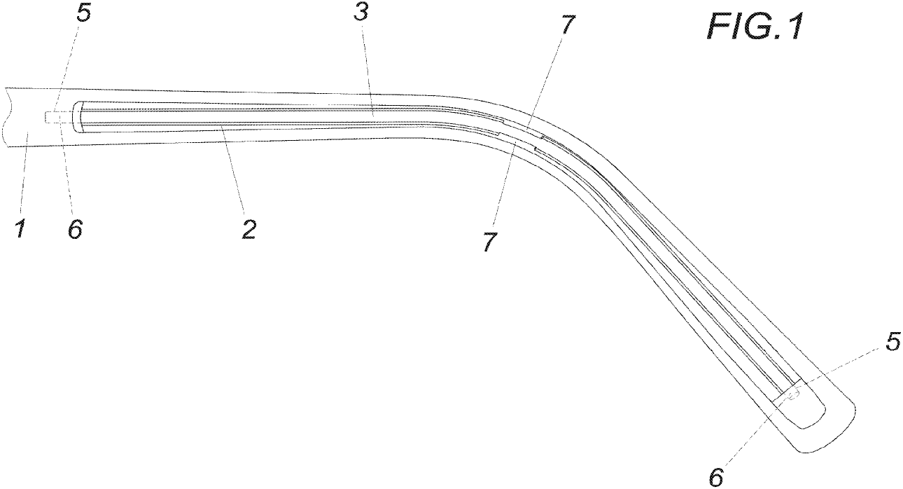

FIG. 1 shows an arm body of a spectacle arm according to the invention in the region of the receiving recess for the support inlay in a view of the side with the longitudinal groove;

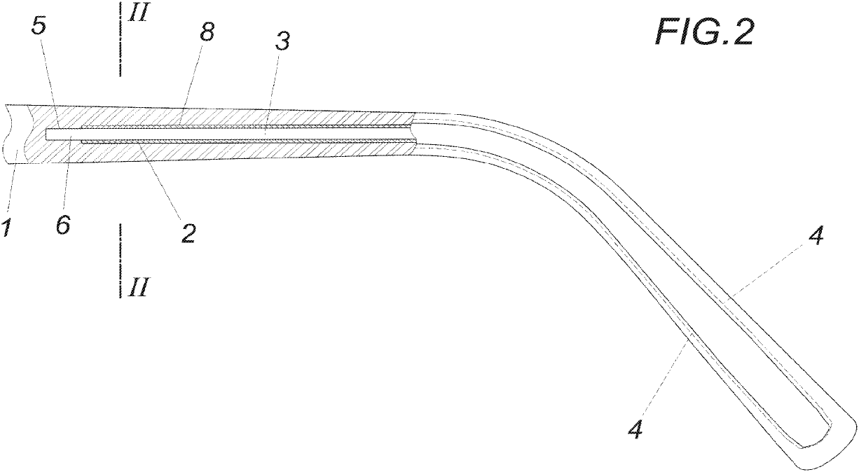

FIG. 2 shows the finished spectacle arm in a partially exposed view according to FIG. 2, and

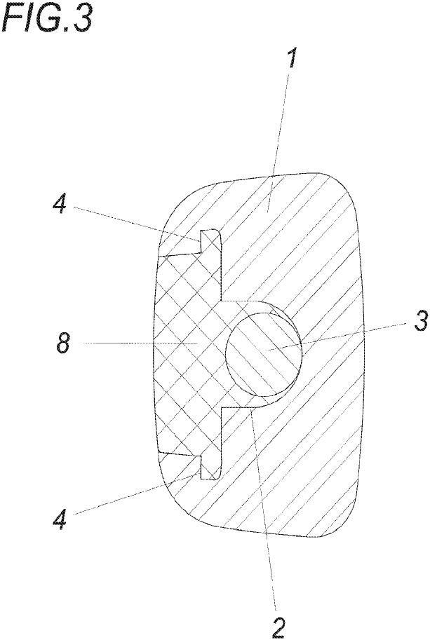

FIG. 3 shows a section along line III-III of FIG. 1 on a larger scale.

### DETAILED DESCRIPTION OF THE PREFERRED EMBODIMENTS

FIG. 1 shows the arm body 1, which is additively manufactured from plastic, with the receiving recess in the form of a longitudinal groove 2 for a support inlay 3. This longitudinal groove 2 has an undercut 4, as can be seen in particular in FIG. 3. Blind holes 5 are provided at the end faces of the longitudinal groove 2, in which the ends 6 of the support inlay 3 engage in order to hold the support inlay 3 within the longitudinal groove 2. In addition, clamping catches 7 are provided along the longitudinal groove 2 to serve the same purpose.

Since, in contrast to production by injection molding, demoldability does not have to be taken into account in additive manufacturing of the arm body 1, comparatively simple manufacturing conditions are obtained with regard to the production of the arm body 1 with the longitudinal groove 2, which is nevertheless of complex design due to the undercut 4 and the blind holes 5 on the end face.

In order to connect the support inlay 3, which is inserted into the longitudinal groove 2 as shown in FIG. 1, to the arm body 1 in a form-fitting manner, the longitudinal groove 2 with the support inlay 3 is injected with plastic. The injection mold required for this is simple, because all that is needed is for the inserted arm body to fit tightly against the mold along the longitudinal groove. After demolding, the plastic injection molding 8 completely covers the longitudinal groove 2 as shown in FIGS. 2 and 3 and ensures a connection between the arm body 1 and the support inlay 3 that meets all requirements.

1. A method for producing a spectacle arm that has an arm body of plastic and a metallic support inlay, said method comprising:
forming the arm body additively with a receiving recess configured to receive the support inlay; and
introducing the support inlay into the receiving recess of the arm body;
wherein the forming of the arm body additively forms the receiving recess with a longitudinal groove that extends at least along a portion of the arm body; and
wherein the longitudinal groove with the inserted support inlay is injected with plastic.

2. The method according to claim 1, wherein the method further comprises subjecting the additively formed arm body to surface treatment and/or providing the additively formed arm body with a coating before said introducing of the support inlay.

3. The method according to claim 1, wherein the method further comprises subjecting the additively formed arm body to surface treatment and/or providing the additively formed arm body with a coating after the injecting of the longitudinal groove with the support inlay with plastic.

4. A spectacle arm comprising:
an arm body formed additively from plastic, said arm body having a receiving recess therein, and a metallic support inlay in the receiving recess of the arm body;
the receiving recess being configured as a longitudinal groove extending at least along an arm body section; and
wherein the longitudinal groove with the support inlay inserted therein has a plastic injection molding closing the longitudinal groove.

5. The spectacle arm according to claim 4, wherein the longitudinal groove has end faces with blind holes thereon, and ends of the support inlay engage in the blind holes on the end faces of the longitudinal groove.

6. The spectacle arm according to claim 4, wherein the longitudinal groove has clamping catches distributed over its a length thereof securing the inserted support inlay.

7. The spectacle arm according to claim 4, wherein the longitudinal groove forms an undercut.

8. The spectacle arm according to claim 5, wherein the longitudinal groove has clamping catches distributed over a length thereof securing the inserted support inlay.

9. The spectacle arm according to claim 5, wherein the longitudinal groove forms an undercut.

10. The spectacle arm according to claim 6, wherein the longitudinal groove forms an undercut.

11. The spectacle arm according to claim 8, wherein the longitudinal groove forms an undercut.
